(19) United States
(12) Patent Application Publication
(10) Pub. No.: US 2026/0031022 A1
(43) Pub. Date: Jan. 29, 2026

(54) GATE DRIVER, DISPLAY DEVICE INCLUDING THE GATE DRIVER, AND ELECTRONIC DEVICE INCLUDING THE DISPLAY DEVICE

(71) Applicant: SAMSUNG DISPLAY CO., LTD., YONGIN-SI (KR)

(72) Inventors: JUNHYUN PARK, Yongin-si (KR); SUNKWUN SON, Yongin-si (KR); CHEOL-GON LEE, Yongin-si (KR)

(21) Appl. No.: 19/210,481

(22) Filed: May 16, 2025

(30) Foreign Application Priority Data
Jul. 19, 2024 (KR) 10-2024-0095600

(51) Int. Cl. G09G 3/32

(52) U.S. Cl. CPC G09G 3/32; G09G 2300/0819; G09G 2310/0267; G09G 2310/0275; G09G 2310/08

(57) ABSTRACT

A gate driver includes a plurality of stages. Each of the stages includes a control circuit configured to control a voltage of at least one control node and a voltage of at least one inversion control node, an odd gate output circuit configured to output an odd gate signal in response to the voltage of the at least one control node and the voltage of the at least one inversion control node, and an even gate output circuit configured to output an even gate signal in response to the voltage of the at least one control node and the voltage of the at least one inversion control node. The odd gate signal is applied to an odd pixel, the even gate signal is applied to an even pixel, the odd pixel and the even pixel are included in a same pixel row, and the odd pixel and the even pixel share one data line.

### CROSS REFERENCE TO RELATED APPLICATION(S)

This application claims priority under 35 USC § 119 to Korean Patent Application No. 10-2024-0095600 filed on Jul. 19, 2024 in the Korean Intellectual Property Office (KIPO), the entire disclosure of which is incorporated by reference herein.

### FIELD

This disclosure relates generally to a gate driver, a display device including the gate driver, and an electronic device including the display device, and more particularly, to reducing dead space in the gate driver, display device and electronic device. Discussion of Related Art

In general, a display device includes a display panel and a display panel driver. The display panel includes gate lines, data lines, and pixels. The display panel driver includes a gate driver for providing a gate signal to the gate lines, a data driver for providing a data voltage to the data lines, and a driving controller for controlling the gate driver and the data driver.

The data driver may provide the data voltage to the data lines through output channels connected to the data lines. The data driver may use a demultiplexer to reduce a number of the output channels. When the data driver uses the demultiplexer, one output channel may be selectively connected to at least two data lines. Therefore, the number of the output channels may be reduced. However, when the data driver uses the demultiplexer, a large dead space may exist at a top or bottom of the display device.

### SUMMARY

Embodiments of the present inventive concept provide a gate driver that omits a demultiplexer for reducing a dead space.

Embodiments of the present inventive concept provide a display device including the gate driver.

Embodiments of the present inventive concept provide an electronic device including the display device.

In an embodiment of a gate driver according to the present inventive concept, the gate driver includes a plurality of stages. Each of the stages includes a control circuit configured to control a voltage of at least one control node and a voltage of at least one inversion control node, an odd gate output circuit configured to output an odd gate signal in response to the voltage of the at least one control node and the voltage of the at least one inversion control node, and an even gate output circuit configured to output an even gate signal in response to the voltage of the at least one control node and the voltage of the at least one inversion control node. The odd gate signal is applied to an odd pixel, the even gate signal is applied to an even pixel, the odd pixel and the even pixel are included in a same pixel row, and the odd pixel and the even pixel share one data line.

In an embodiment, a period in which the odd gate signal has an activation level differs from a period in which the even gate signal has the activation level may be different.

In an embodiment, the odd pixels and the even pixels may be arranged adjacent to each other.

In an embodiment, the at least one inversion control node may include a first inversion control node and a second inversion control node, and the control circuit may comprise an input circuit configured to provide an input signal to the control node and a reset circuit configured to reset the voltage of the control node.

In an embodiment, the input circuit may comprise a first transistor pair including a gate electrode (“gate”) receiving a first carry clock signal, a first electrode receiving an input signal, and a second electrode connected to the control node, and the reset circuit may comprise a second transistor pair including a gate electrode receiving a reset signal, a first electrode receiving a first low gate voltage, and a second electrode connected to the control node.

In an embodiment, the control circuit may further comprise a deterioration prevention circuit configured to prevent a deterioration of the first transistor of the input circuit and a deterioration of the second transistor of the reset circuit.

In an embodiment, the deterioration prevention circuit may include a gate electrode connected to the control node, a first electrode receiving a high gate voltage, and a second electrode connected to a middle node of the first transistor pair and a middle node of the second transistor pair.

In an embodiment, the inversion control node may include a first inversion control node and a second inversion control node, and the control circuit may further include a first selection circuit configured to control a voltage of the first inversion control node in response to a first selection signal and a second selection circuit configured to control a voltage of the second inversion control node in response to a second selection signal.

In an embodiment, the first selection circuit may comprise a thirteenth transistor pair (“thirteenth transistor”) including a gate electrode receiving the first selection signal, a first electrode receiving the first selection signal, and a second electrode, a fourteenth transistor including a gate electrode connected to the second electrode of the thirteenth transistor, a first electrode receiving the first selection signal, and a second electrode connected to the first inversion control node, a fifteenth transistor including a gate electrode connected to the control node, a first electrode receiving a first low gate voltage, and a second electrode connected to the second electrode of the thirteenth transistor and the gate electrode of the fourteenth transistor, a sixteenth transistor including a gate electrode connected to the control node, a first electrode receiving a second low gate voltage, and a second electrode connected to the first inversion control node, and a third capacitor including a first electrode connected to the second electrode of the thirteenth transistor, the gate electrode of the fourteenth transistor, and a first electrode of the fifteenth transistor, and a second electrode connected to the first inversion control node, and the second selection circuit may comprise a seventeenth transistor pair (“seventeenth transistor”) including a gate electrode receiving the second selection signal, a first electrode receiving the second selection signal, and a second electrode, an eighteenth transistor including a gate electrode connected to the second electrode of the seventeenth transistor, a first electrode receiving the second selection signal, and a second electrode connected to the second inversion control node, a nineteenth transistor including a gate electrode connected to the control node, a first electrode receiving the first low gate voltage, and a second electrode connected to the second electrode of the seventeenth transistor and the gate electrode of the eighteenth transistor, a twentieth transistor including a gate electrode connected to the control node, a first electrode receiving the second low gate voltage, and a second electrode connected to the second inversion control node, and a fourth capacitor including a first electrode connected to the second electrode of the seventeenth transistor, the gate electrode of the eighteenth transistor and a second electrode connected to the second inversion control node.

In an embodiment, the gate driver may further comprise a carry output circuit configured to output a carry signal in response to the voltage of the control node and the voltage of the inversion control node.

In an embodiment, the inversion control node may include a first inversion control node and a second inversion control node, and the carry output circuit may comprise a fourth transistor including a gate electrode receiving a second carry clock signal, a first electrode connected to the control node, and a second electrode, a fifth transistor including a gate electrode connected to the first inversion control node, a first electrode connected to the second electrode of the fourth transistor, and a second electrode connected to a carry output node from which a carry signal is output, a sixth transistor including a gate electrode connected to the second inversion control node, a first electrode connected to the second electrode of the fourth transistor and the first electrode of the fifth transistor, and a second electrode connected to the carry output node, a seventh transistor including a gate electrode connected to the control node, a first electrode receiving the second carry clock signal, and a second electrode connected to the carry output node, an eighth transistor including a gate electrode connected to the first inversion control node, and a first electrode receiving a second low gate voltage, and a second electrode connected to the carry output node, and a ninth transistor including a gate electrode connected to the second inversion control node, a first electrode receiving the second low gate voltage, and a second electrode connected to the carry output node.

In an embodiment, the inversion control node may include a first inversion control node and a second inversion control node, and the odd gate output circuit may comprise a tenth odd transistor including a gate electrode connected to the control node, a first electrode receiving an odd clock signal, and a second electrode connected to an odd gate output node from which the odd gate signal is output, a eleventh odd transistor including a gate electrode connected to the first inversion control node, a first electrode receiving a first low gate voltage, and a second electrode connected to the odd gate output node, and a twelfth odd transistor including a gate electrode connected to the second inversion control node, a first electrode receiving the first low gate voltage, and a second electrode connected to the odd gate output node.

In an embodiment, the control node may include a first control node and a second control node, and the odd gate output circuit may further comprise an odd always-on transistor including a gate electrode receiving a high gate signal, a first electrode connected to the first control node, and a second electrode connected to the second control node.

In an embodiment, the inversion control node may include a first inversion control node and a second inversion control node, and the even gate output circuit may comprise a tenth even transistor including a gate electrode connected to the control node, a first electrode receiving an even clock signal, and a second electrode connected to an even gate output node from which the even gate signal is output, a eleventh even transistor including a gate electrode connected to the first inversion control node, a first electrode receiving a low gate voltage, and a second electrode connected to the even gate output node, and a twelfth even transistor including a gate electrode connected to the second inversion control node, a first electrode receiving a first low gate voltage, and a second electrode connected to the even gate output node.

In an embodiment, the control node may include a first control node and a third control node, and the even gate output circuit may further comprise an odd always-on transistor including a gate electrode receiving a high gate signal, a first electrode connected to the first control node, and a second electrode connected to the third control node.

In an embodiment of a display device according to the present inventive concept, the display device includes a display panel including an odd pixel and an even pixel included in a same pixel row and sharing one data line, a data driver configured to provide an odd data voltage and an even data voltage to the one data line, a gate driver configured to provide an odd gate signal and an even gate signal to the odd pixel and the even pixel, and a driving controller configured to control the data driver and the gate driver. The odd pixel receives the odd data voltage in response to the odd gate signal, and the even pixel receives the even data voltage in response to the even gate signal. The gate driver comprises a plurality of stages. Each of the stages includes a control circuit configured to control a voltage of at least one control node and a voltage of at least one inversion control node, an odd gate output circuit configured to output an odd gate signal in response to the voltage of the at least one control node and the voltage of the at least one inversion control node, and an even gate output circuit configured to output an even gate signal in response to the voltage of the at least one control node and the voltage of the at least one inversion control node.

In an embodiment of an electronic device according to the present inventive concept, the electronic device includes a display panel including an odd pixel and an even pixel included in a same pixel row and sharing one data line, a data driver configured to provide an odd data voltage and an even data voltage to the one data line, a gate driver configured to provide an odd gate signal and an even gate signal to the odd pixel and the even pixel, a driving controller configured to control the data driver and the gate driver, and a processor configured to control the driving controller. The odd pixel receives the odd data voltage in response to the odd gate signal, and the even pixel receives the even data voltage in response to the even gate signal. The gate driver comprises a plurality of stages. Each of the stages comprises a control circuit configured to control a voltage of at least one control node and a voltage of at least one inversion control node, an odd gate output circuit configured to output an odd gate signal in response to the voltage of the at least one control node and the voltage of the at least one inversion control node, and an even gate output circuit configured to output an even gate signal in response to the voltage of the at least one control node and the voltage of the at least one inversion control node.

According to the gate driver, the display device including the gate driver, and the electronic device including the display device, the gate driver includes a plurality of stages. Each of the stages includes a control circuit configured to control a voltage of at least one control node and a voltage of at least one inversion control node, an odd gate output circuit configured to output an odd gate signal in response to the voltage of the control node and the voltage of the inversion control node, and an even gate output circuit configured to output an even gate signal in response to the voltage of the control node and the voltage of the inversion control node. The odd gate signal is applied to an odd pixel, the even gate signal is applied to an even pixel, the odd pixel and the even pixel are included in a same pixel row, and the odd pixel and the even pixel share one data line. Accordingly, even if the display device omits a demultiplexer, a demultiplexing function may be performed.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram showing a display device according to embodiments of the present inventive concept;

FIG. 2 is a circuit diagram showing an example of pixels of FIG. 1;

FIG. 3 and FIG. 4 are circuit diagrams showing an operation of pixels of FIG. 2;

FIG. 5 is a block diagram showing a gate driver of FIG. 1;

FIG. 6 is a timing diagram showing first to fourth carry clock signals, first to fourth odd clock signals, and the first to fourth even clock signals of FIG. 5;

FIG. 7 is a circuit diagram showing a first stage of FIG. 5;

FIG. 8 is a timing diagram showing a first carry clock signal, a third carry clock signal, a third odd clock signal, a third even clock signal, a voltage of a first control node, a voltage of a second inversion control node, a first carry signal, a first odd gate signal, and a first even gate signal of FIG. 7;

FIG. 9 is a block diagram showing an electronic device; and

FIG. 10 is a diagram showing an embodiment in which an electronic device of FIG. 9 is implemented as a smart phone.

### DETAILED DESCRIPTION OF EMBODIMENTS

Hereinafter, the present inventive concept will be described in more detail with reference to the accompanying drawings.

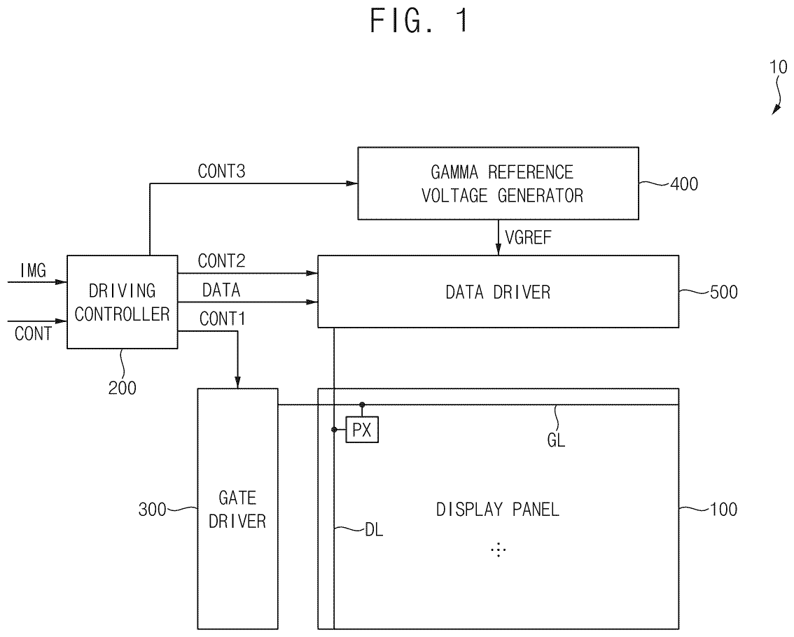

FIG. 1 is a block diagram showing a display device 10 according to embodiments of the present inventive concept.

Referring to FIG. 1, a display device 10 may include a display panel 100 and a display panel driver. The display panel driver may include a driving controller 200, a gate driver 300, a gamma reference voltage generator 400, and a data driver 500.

The display panel 100 may include a display area for displaying an image and a peripheral area arranged adjacent to the display area.

The display panel 100 may include gate lines GL, data lines DL, and pixels PX electrically connected to the gate lines GL and the data lines DL, respectively. The gate lines GL may extend in a first direction, and the data lines DL may extend in a second direction crossing the first direction.

The driving controller 200 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal (which may include multiple clock signals).

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400. The gate driver 300 may generate gate signals for driving the gate lines GL in response to the first control signal CONT1 received from the driving controller 200. The gate driver 300 may output the gate signals to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be arranged in the driving controller 200 or may be arranged in the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage into an analog type of data voltage using the gamma reference voltage VGREF. The data driver 500 may output the data voltage to the data line DL.

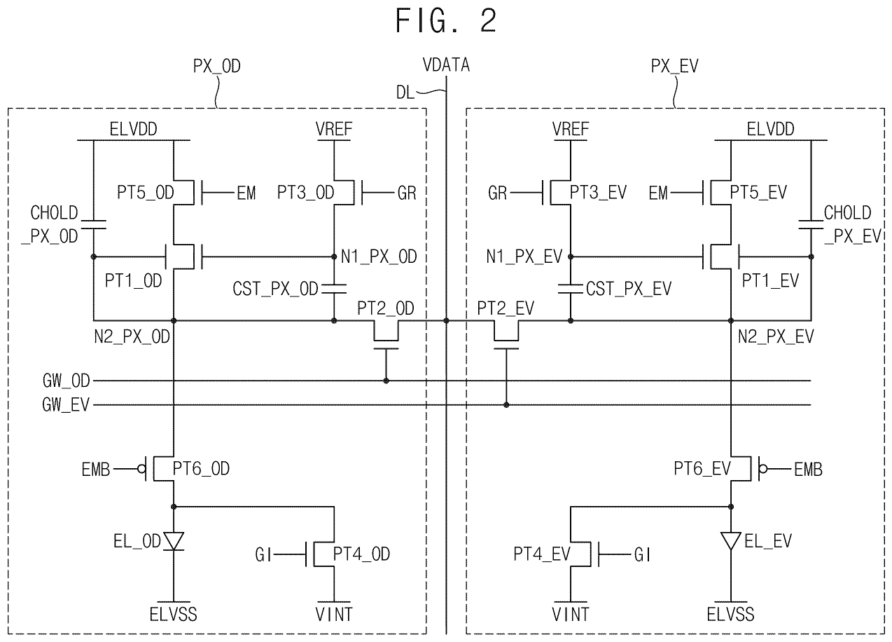

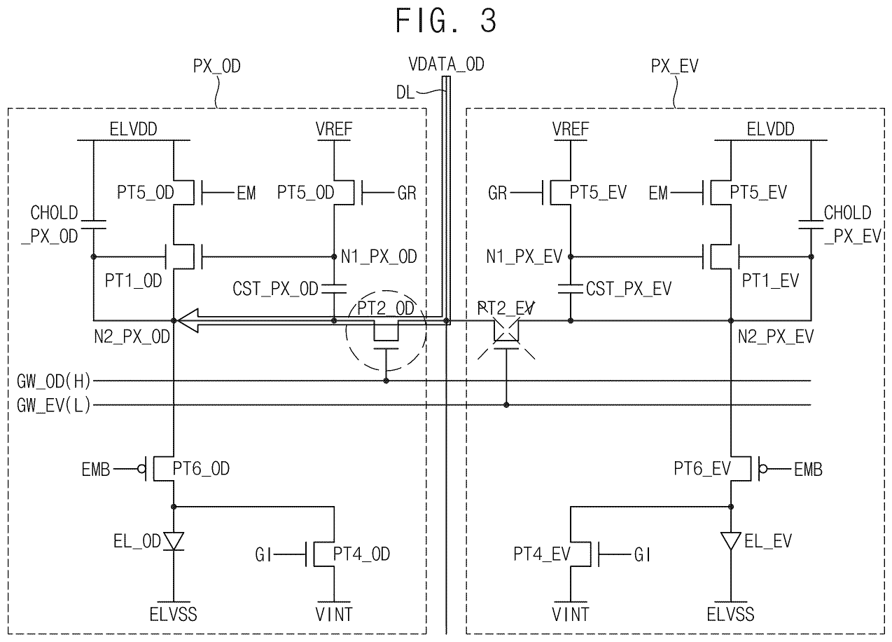

FIG. 2 is a circuit diagram showing an example of pixels PX of FIG. 1. FIG. 3 and FIG. 4 are circuit diagrams showing an operation of the pixels of FIG. 2.

Referring to FIG. 2, a display panel 100 may include odd pixels PX_OD and even pixels PX_EV, which may be included in a same pixel row and may be arranged adjacent to each other.

The odd pixel PX_OD may include a first odd transistor PT1_OD, a second odd transistor PT2_OD, a third odd transistor PT3_OD, a fourth odd transistor PT4_OD, a fifth odd transistor PT5_OD, a sixth odd transistor PT6_OD, an odd storage capacitor CST_PX_OD, an odd hold capacitor CHOLD_PX_OD, and an odd light emitting element EL_OD. For example, the first odd transistor PT1_OD, the second odd transistor PT2_OD, the third odd transistor PT3_OD, the fourth odd transistor PT4_OD, and the fifth odd transistor PT5_OD may be NMOS transistors. For example, the sixth odd transistor PT6_OD may be a PMOS transistor.

The first odd transistor PT1_OD may include a gate electrode connected to a first odd node N1_PX_OD, a first electrode, a second electrode connected to a second odd node N2_PX_OD, and a back gate electrode connected to the second odd node N2_PX_OD. (Herein, a “first electrode” of an NMOS or PMOS transistor is a source or a drain of the transistor, and a “second electrode” of the transistor is the other of the source or the drain.) The second odd transistor PT2_OD may include a gate electrode receiving an odd write gate signal GW_OD, a first electrode connected to a data line DL transmitting a data voltage VDATA, and a second electrode connected to the second odd node N2_PX_OD. The third odd transistor PT3_OD may include a gate electrode receiving a reference gate signal GR, a first electrode receiving a reference voltage VREF, and a second electrode connected to the first odd node N1_PX_OD. The fourth odd transistor PT4_OD may include a gate electrode receiving an initialization gate signal GI, a first electrode receiving an initialization voltage VINT, and a second electrode. The fifth odd transistor PT5_OD may include a gate electrode receiving an emission signal EM, a first electrode receiving a first power supply voltage ELVDD, and a second electrode connected to the first electrode of the first odd transistor PT1_OD. The sixth odd transistor PT6_OD may include a gate electrode receiving an inversion emission signal EMB (applied from an inversion control node of the gate driver 300, discussed below), a first electrode connected to the second odd node N2_PX_OD, and a second electrode connected to the second electrode of the fourth odd transistor PT4_OD. The odd storage capacitor CST_PX_OD may include a first electrode connected to the first odd node N1_PX_OD and a second electrode connected to the second odd node N2_PX_OD. The odd hold capacitor CHOLD_PX_OD may include a first electrode receiving the first power supply voltage ELVDD and a second electrode connected to the second odd node N2_PX_OD. The odd light emitting element EL_OD may include an anode connected to the second electrode of the fourth odd transistor PT4_OD and the second electrode of the sixth odd transistor PT6_OD and a cathode receiving a second power supply voltage ELVSS.

The even pixel PX_EV may include a first even transistor PT1_EV, a second even transistor PT2_EV, a third even transistor PT3_EV, a fourth even transistor PT4_EV, a fifth even transistor PT5_EV, a sixth even transistor PT6_EV, an even storage capacitor CST_PX_EV, an even hold capacitor CHOLD_PX_EV, and an even light emitting element EL_EV. For example, the first even transistor PT1_EV, the second even transistor PT2_EV, the third even transistor PT3_EV, the fourth even transistor PT4_EV, and the fifth even transistor PT5_EV may be the NMOS transistors. For example, the sixth even transistor PT6_EV may be the PMOS transistor.

The first even transistor PT1_EV may include a gate electrode connected to a first even node N1_PX_EV, a first electrode, a second electrode connected to a second even node N2_PX_EV, and a back gate electrode connected to the second even node N2_PX_EV. The second even transistor PT2_EV may include a gate electrode receiving an even write gate signal GW_EV, a first electrode connected to the data line DL transmitting the data voltage VDATA, and a second electrode connected to the second even node N2_PX_EV. The third even transistor PT3_EV may include a gate electrode receiving the reference gate signal GR, a first electrode receiving a reference voltage VREF, and a second electrode connected to the first even node N1_PX_EV. The fourth even transistor PT4_EV may include a gate electrode receiving the initialization gate signal GI, a first electrode receiving the initialization voltage VINT, and a second electrode. The fifth even transistor PT5_EV may include a gate electrode receiving the emission signal EM, a first electrode receiving a first power supply voltage ELVDD, and a second electrode connected to the first electrode of the first even transistor PT1_EV. The sixth even transistor PT6_EV may include a gate electrode receiving the inversion emission signal EMB, a first electrode connected to the second even node N2_PX_EV, and a second electrode connected to the second electrode of the fourth even transistor PT4_EV. The even storage capacitor CST_PX_EV may include a first electrode connected to the first even node N1_PX_EV and a second electrode connected to the second even node N2_PX_EV. The even hold capacitor CHOLD_PX_EV may include a first electrode receiving the first power supply voltage ELVDD and a second electrode connected to the second even node N2_PX_EV. The even light emitting element EL_EV may include an anode connected to the second electrode of the fourth even transistor PT4_EV and the second electrode of the sixth even transistor PT6_EV and a cathode receiving the second power supply voltage ELVSS.

When a display device includes a demultiplexer, one channel from which the data voltage VDATA is output may be selectively connected to at least two data lines DL. For example, when one channel may be selectively connected to at least two data lines DL, the number of channels may be reduced by half. However, although a method of using the demultiplexer reduce the number of channels, a large dead space may exist at a top or bottom of the display device 10. In order to prevent the dead space, the odd pixel PX_OD and the even pixel PX_EV may share one data line DL, and the odd write gate signal GW_OD and the even write gate signal GW_EV may controlled such that the data voltage VDATA transmitted through the data line DL may be selectively applied to the odd pixel PX_OD and the even pixel PX_EV. Since the odd pixel PX_OD and the even pixel PX_EV may share one data line DL, the number of channels may be reduced by half. Accordingly, a function of the demultiplexer may be performed.

As such, the odd pixel PX_OD and the even pixel PX_EV may share one data line DL. In addition, the odd write gate signal GW_OD may be applied to the odd pixel PX_OD, and the even write gate signal GW_EV may be applied to the even pixel PX_EV. Here, a period in which the odd write gate signal GW_OD has an activation level may differ from a period in which the even write gate signal GW_EV has the activation level. Here, the activation level of the NMOS transistor may be a high level, and the activation level of the PMOS transistor may be a low level.

FIG. 3 illustrates an operation of applying a data voltage to an odd pixel. In this case, the data voltage VDATA may have an odd data voltage VDATA_OD. The second odd transistor PT2_OD may be turned on in response to an odd write gate signal GW_OD having a high level H to provide the odd data voltage VDATA_OD to the second odd node N2_PX_OD. The second even transistor PT2_EV may be turned off in response to an even write gate signal GW_EV having a low level L. Therefore, the odd data voltage VDATA_OD may not be provided to the second even node N2_PX_EV.

FIG. 4 illustrates an operation of applying a data voltage to an even pixel. In this case, the data voltage VDATA may have an even data voltage VDATA_EV. The second even transistor PT2_EV may be turned on in response to the even write gate signal GW_EV having the high level H to provide the even data voltage VDATA_EV to the second even node N2_PX_EV. The second odd transistor PT2_OD may be turned off in response to the odd write gate signal GW_OD having the low level L. Therefore, the even data voltage VDATA_EV may not be provided to the second odd node N2_PX_OD.

As such, when the odd pixel PX_OD and the even pixel PX_EV share the one data line DL, the odd write gate signal GW_OD is applied to the odd pixel PX_OD, and the even write gate signal GW_EV is applied to the even pixel PX_EV, a number of data lines DL and a number of output channels may be reduced. Accordingly, a function of a demultiplexer may be performed.

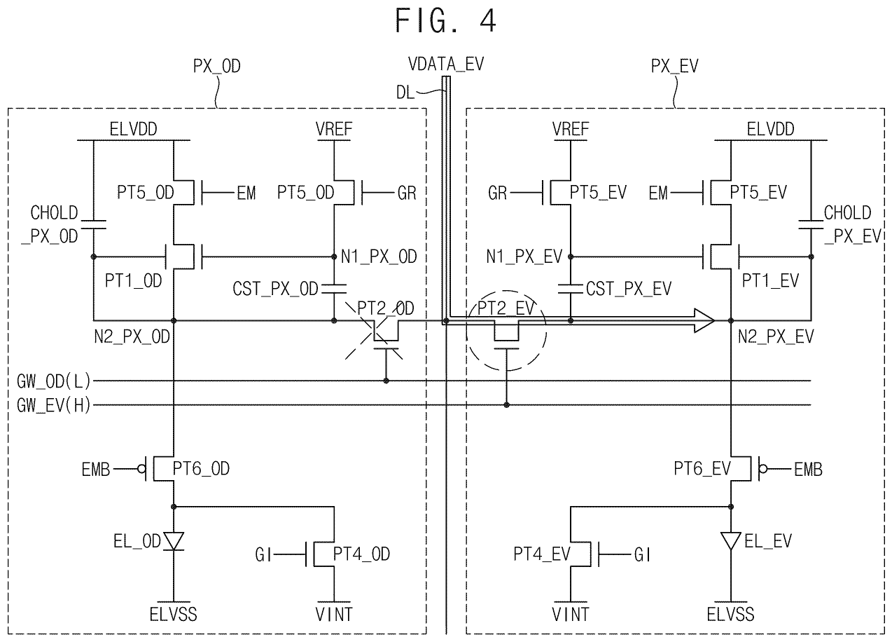

The gate driver 300 may generate the odd write gate signal GW_OD and the even write gate signal GW_EV. In FIGS. 5 to 8, an example of the gate driver 300 which generates the odd write gate signal GW_OD and the even write gate signal GW_EV will be described in detail.

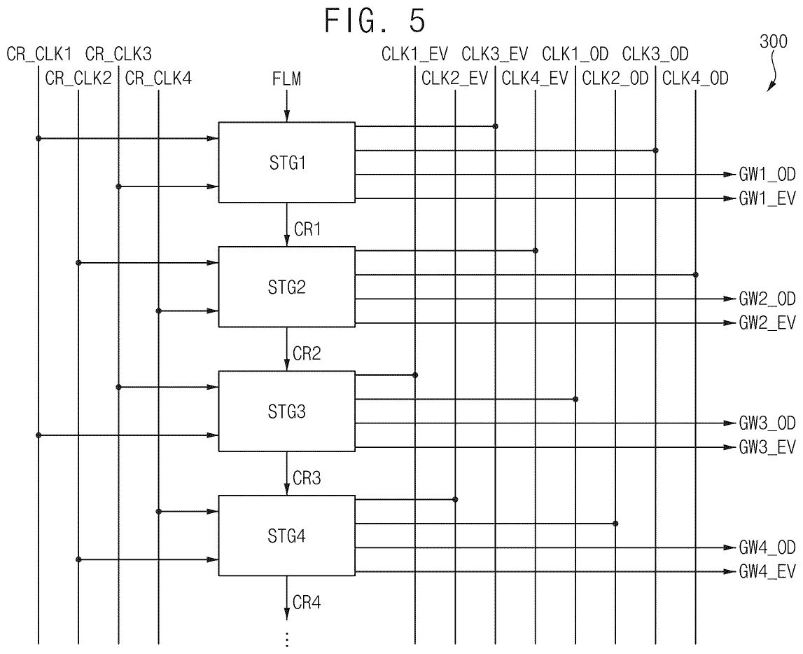

FIG. 5 is a block diagram showing an example gate driver 300 of FIG. 1. FIG. 6 is a timing diagram showing first to fourth carry clock signals CR_CLK1 to CR_CLK4, first to fourth odd clock signals CLK1_OD to CLK4_OD, and first to fourth even clock signals CLK1_EV to CLK4_EV of FIG. 5.

Referring to FIG. 5 and FIG. 6, a gate driver 300 may include a plurality of stages STG1, STG2, STG3, STG4, . . . . The stages STG1, STG2, STG3, STG4, . . . may receive a gate start signal FLM, first to fourth carry clock signals CR_CLK1 to CR_CLK4, first to fourth odd clock signals CLK1_OD to CLK4_OD, and first to fourth even clock signals CLK1_EV to CLK4_EV from the driving controller 200 (all may be included in the CONT1 signal). The stages STG1, STG2, STG3, STG4, . . . may sequentially output carry signals CR1, CR2, CR3, CR4, . . . . The stages STG1, STG2, STG3, STG4, . . . may sequentially output odd gate signals GW1_OD, GW2_OD, GW3_OD, GW4_OD, . . . . The stages STG1, STG2, STG3, STG4, . . . may sequentially output even gate signals GW1_EV, GW2_EV, GW3_EV, GW4_EV, . . . (As is known to those skilled in the art, a carry signal may refer to a signal that is passed from one stage of a gate driver to the next, and may act as a trigger to indicate when to apply a new set of data to the next row of pixels to update the images produced thereby.)

A first stage STG1 may receive the gate start signal FLM as an input signal, and subsequent stages STG2, STG3, . . . may receive the carry signals CR1, CR2, CR3, CR4, . . . as the input signals.

The carry signals CR[1], CR[2], CR[3], . . . may have different respective timings. The odd gate signals GW1_OD, GW2_OD, GW3_OD, GW4_OD, . . . may have different respective timings. The even gate signals GW1_EV, GW2_EV, GW3_EV, GW4_EV, . . . may have different timings.

For example, the first stage STG1 may receive the gate start signal FLM as the input signal in response to the first carry clock signal CR_CLK1. The first stage STG1 may output a first carry signal CR1 based on the third carry clock signal CR_CLK3. The first stage STG1 may output a first odd gate signal GW1_OD based on the third odd clock signal CLK3_OD. The first stage STG1 may output a first even gate signal GW1_EV based on the third even clock signal CLK3_EV. The first odd gate signal GW1_OD may be applied to odd pixels of the first pixel row. The first even gate signal GW1_EV may be applied to even pixels of the first pixel row.

For example, the second stage STG2 may receive the first carry signal CR1 as the input signal in response to the second carry clock signal CR_CLK2. The second stage STG2 may output a second carry signal CR2 based on the fourth carry clock signal CR_CLK4. The second stage STG2 may output a second odd gate signal GW2_OD based on the fourth odd clock signal CLK4_OD. The second stage STG2 may output a second even gate signal GW2_EV based on the fourth even clock signal CLK4_EV. The second odd gate signal GW2_OD may be applied to odd pixels of the second pixel row. The second even gate signal GW2_EV may be applied to even pixels of the second pixel row.

For example, the third stage STG3 may receive the second carry signal CR2 as the input signal in response to the third carry clock signal CR_CLK3. The third stage STG3 may output a third carry signal CR3 based on the first carry clock signal CR_CLK1. The third stage STG3 may output a third odd gate signal GW3_OD based on the first odd clock signal CLK1_OD. The third stage STG3 may output a third even gate signal GW3_EV based on the first even clock signal CLK1_EV. The third odd gate signal GW3_OD may be applied to odd pixels of the third pixel row. The third even gate signal GW3_EV may be applied to even pixels of the third pixel row.

For example, the fourth stage STG4 may receive the third carry signal CR3 as the input signal in response to the fourth carry clock signal CR_CLK4. The fourth stage STG4 may output a fourth carry signal CR4 based on the second carry clock signal CR_CLK2. The fourth stage STG4 may output a fourth odd gate signal GW4_OD based on the second odd clock signal CLK2_OD. The fourth stage STG4 may output a fourth even gate signal GW4_EV based on the second even clock signal CLK2_EV. The fourth odd gate signal GW4_OD may be applied to odd pixels of the fourth pixel row. The fourth even gate signal GW4_EV may be applied to even pixels of the fourth pixel row.

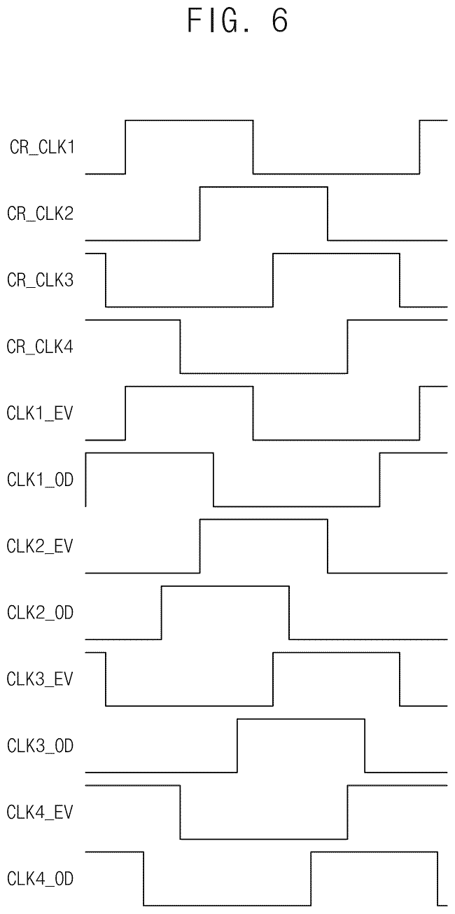

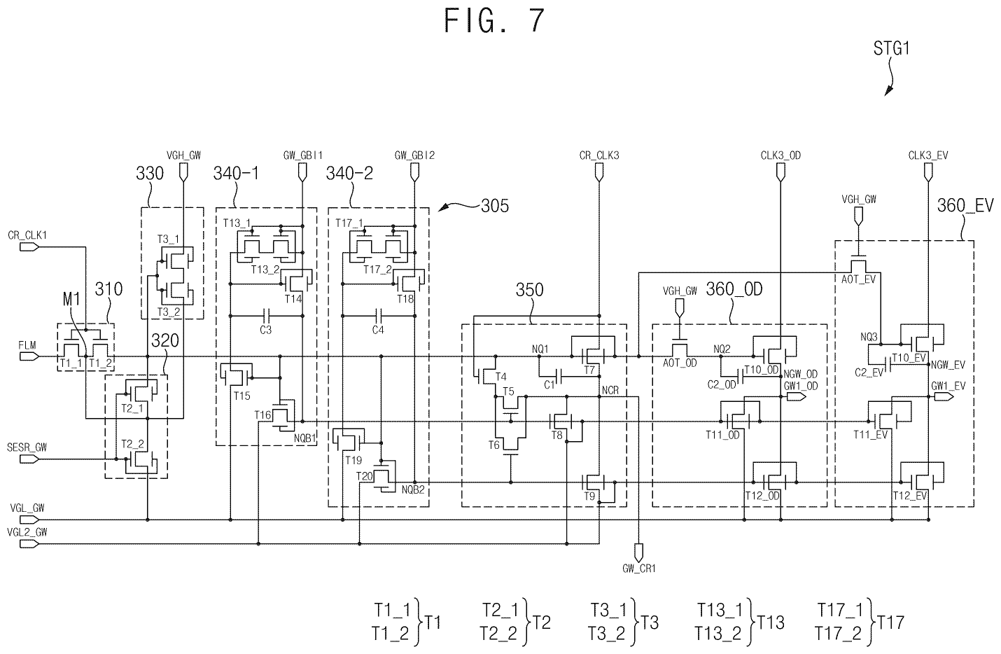

FIG. 7 is a circuit diagram showing an example of a first stage STG1 of FIG. 5. FIG. 8 is a timing diagram showing examples of a first carry clock signal CR_CLK1, a third carry clock signal CR_CLK3, a third odd clock signal CLK3_OD, a third even clock signal CLK3_EV, a voltage of a first control node NQ1, a voltage of a second inversion control node NQB2, a first carry signal CR1, a first odd gate signal GW1_OD, and a first even gate signal GW1_EV of FIG. 7.

Referring to FIGS. 7 and 8, a gate driver 300 according to embodiments of the present inventive concept may include a plurality of stages STG1, STG2, STG3, STG4, . . . . The stages STG1, STG2, STG3, STG4, . . . have substantially the same configuration and the same operation. Therefore, in FIG. 7, a first stage STG1 of FIG. 5 is described, and a description of subsequent stages STG2, STG3, STG4, . . . of FIG. 5 is omitted. Note, however, that while the first stage STG1 receives a gate start signal FLM at an input circuit 310, the subsequent stages STG2, STG3, STG4 . . . receive a carry signal CR1, CR2, CR3, . . . (see FIG. 5) at the input circuit 310.

A first stage STG1 may include a control circuit 305, a carry output circuit 350, an odd gate output circuit 360_OD, and an even gate output circuit 360_EV. The control circuit 305 may include the input circuit 310, a reset circuit 320, a deterioration prevention circuit 330, a first selection circuit 340-1, and a second selection circuit 340-2. The control circuit 305 may control respective voltages of a first control node NQ1, a second control node NQ2 and a third control node NQ3, and voltages of a first inversion control node NQB1 and a second inversion control node NQB2. The odd gate output circuit 360_OD may output a first odd gate signal GW1_OD in response to at least one voltage of the control nodes NQ1, NQ2 and NQ3 and at least one voltage of the inversion control nodes NQB1 and NQB2. The even gate output circuit 360_EV may output a first even gate signal GW1_EV in response to at least one voltage of the control nodes NQ1, NQ2 and NQ3 and at least one voltage of the inversion control nodes NQB1 and NQB2.

The input circuit 310 may provide the gate start signal FLM (i.e., an input signal) to the first control node NQ1. The input circuit 310 may include a first “transistor pair” T1 (a pair of transistors) including a transistor T1_1 and a transistor T1_2 connected in series, with gates thereof directly connected and a second electrode thereof directly connected to each other at a “middle node” M1. (Note that the first electrode or the second electrode of a first transistor of a transistor pair that is not connected to a middle node may be considered a first electrode of the transistor pair; and the first electrode or the second electrode of the second transistor of the transistor pair that is not connected to the middle node may be considered a second electrode of the transistor pair.)

The gates of the first transistor pair T1 may receive a first carry clock signal CR_CLK1; a first electrode of transistor T1_1 may receive the gate start signal FLM; and a first electrode of transistor T1_2 may be connected to the first control node NQ1. The transistors T1_1 and T1_2 may each be turned on (i.e., the “transistor pair T1 may be turned on”) in response to the first carry clock signal CR_CLK1 to provide the gate start signal FLM to the first control node NQ1.

The reset circuit 320 may reset a voltage of the first control node NQ1. The reset circuit 320 may include a second transistor pair T2 having transistors T2_1 and T2_2 connected in series and with gates thereof connected to each other.

The gates of the second transistor pair T2 may receive a reset signal SESR_GW. A first electrode of transistor T2_2 may receive a first low gate voltage VGL_GW, and a first electrode of transistor T2_1 may be connected to the first control node NQ1. A second electrode of transistor T2_1 may be connected to a second electrode of transistor T2_2. In an embodiment, the transistors T2_1 and T2_2 may each further include a back gate electrode connected to the respective gate thereof. Including a back gate electrode may enable a threshold voltage adjustment of the transistor, and connecting the back gate electrode to the gate may render the transistor operations more predictable and stable. Transistors T2_1 and T2_2 may each be turned on (the second transistor pair T2 may be turned on) in response to the reset signal SESR_GW to provide the first low gate voltage VGL_GW to the first control node NQ1. Therefore, the voltage of the first control node NQ1 may be reset to the first low gate voltage VGL_GW.

The deterioration prevention circuit 330 may prevent a deterioration of the first transistor pair T1 of the input circuit 310 and a deterioration of the second transistor pair T2 of the reset circuit 320. The deterioration prevention circuit 330 may include a third transistor pair T3 including transistors T3_1 and T3_2 connected in series (with gates connected together and second electrodes connected together).

The gates of the third transistor pair T3 maybe connected to the first control node NQ1; a first electrode of transistor T3_1 may receive a high gate voltage VGH_GW; and a first electrode of transistor T3_2 may be connected to the middle node M1 of the first transistor pair T1 and the middle node of the second transistor pair T2. In an embodiment, each of transistors T3_1 and T3_2 may further include a back gate electrode connected to the gate thereof. The third transistor pair T3 may be turned on in response to the voltage of the first control node NQ1 to provide the high gate voltage VGH_GW to the middle nodes of the each of the first transistor pair T1 and the second transistor pair T2. Therefore, deterioration of the first transistor pair T1 and the second transistor pair T2 may be prevented.

The first selection circuit 340-1 may control a voltage of the first inversion control node NQB1 in response to a first selection signal GW_GBI1. The first selection circuit 340-1 may include a fourteenth transistor T14, a fifteenth transistor T15, a sixteenth transistor T16, a third capacitor C3, and a thirteenth transistor pair T13 including transistors T13_1 and T13_2 connected in series, with gates thereof connected to one another and second electrodes connected to one another.

The gates of the thirteenth transistor pair T13 may receive the first selection signal GW_GBI1; and a second electrode of transistor T13_2 may also receive the first selection signal GW_GBI1. In an embodiment, transistors T13_1 and T13_2 may each further include a back gate electrode connected to the gate thereof. The fourteenth transistor T14 may include a gate connected to a first electrode of transistor T13_1; a first electrode receiving the first selection signal GW_GBI1, and a second electrode connected to the first inversion control node NQB1. In an embodiment, the fourteenth transistor T14 may further include a back gate electrode connected to the gate electrode. The thirteenth transistor T13-1, T13-2 may be turned on in response to the first selection signal GW_GBI1 to provide the first selection signal GW_GBI1 to the gate electrode of the fourteenth transistor T14. The fourteenth transistor T14 may be turned on in response to the first selection signal GW_GBI1 provided from the thirteenth transistor T13-1, T13-2 and may provide the first selection signal GW_GBI1 to the first inversion control node NQB1.

The fifteenth transistor T15 may include a gate connected to the first control node NQ1, a first electrode receiving the first low gate voltage VGL_GW, and a second electrode connected to the first electrode of transistor T13_1 and the gate of the fourteenth transistor T14. In an embodiment, the fifteenth transistor T15 may further include a back gate electrode connected to the gate thereof. The fifteenth transistor T15 may provide the first low gate voltage VGL_GW to the first electrode of T13_1 and the gate of the fourteenth transistor T14 in response to the voltage of the first control node NQ1.

The sixteenth transistor T16 may include a gate connected to the first control node NQ1, a first electrode receiving a second low gate voltage VGL2_GW, and a second electrode connected to the first inversion control node NQB1. In an embodiment, the sixteenth transistor T16 may further include a back gate electrode connected to its gate. The sixteenth transistor T16 may provide the second low gate voltage VGL2 to the first inversion control node NQB1 in response to the voltage of the first control node NQ1.

The third capacitor C3 may include a first electrode connected to the first electrode of transistor T13_1, the gate of the fourteenth transistor T14, and the second electrode of the fifteenth transistor T15, and a second electrode connected to the first inversion control node NQB1.

The second selection circuit 340-2 may control a voltage of the second inversion control node NQB2 in response to a second selection signal GW_GBI2. The second selection circuit 340-2 may include a seventeenth transistor pair T17, an eighteenth transistor T18, a nineteenth transistor T19, a twentieth transistor T20, and a fourth capacitor C4.

The seventeenth transistor pair T17 may include transistors T17_1 and T17_2 with gates connected to one another and receiving the second selection signal GW_GBI2; a first electrode of transistor T17_2 receiving the second selection signal GW_GB12, and second electrodes of transistors T17_1 and T17_2 connected to each other. In an embodiment, each of transistors T17_1 and T17_2 may further include a back gate electrode connected to the gate thereof. The eighteenth transistor T18 may include a gate connected to the first electrode of transistor T17_1, a first electrode receiving the second selection signal GW_GB12, and a second electrode connected to the second inversion control node NQB2. In an embodiment, the eighteenth transistor T18 may further include a back gate electrode connected to its gate. The seventeenth transistor T17 may be turned on in response to the second selection signal GW_GBI2 to provide the second selection signal GW_GBI2 to the gate of the eighteenth transistor T18. The eighteenth transistor T18 may be turned on in response to the second selection signal GW_GBI2 provided from the seventeenth transistor T17 to provide the second selection signal GW_GBI2 to the second inversion control node NQB2.

The nineteenth transistor T19 may include a gate connected to the first control node NQ1, a first electrode receiving the first low gate voltage VGL_GW, and a second electrode connected to the first electrode of transistor T17_1 and the gate of the eighteenth transistor T18. In an embodiment, the nineteenth transistor T19 may further include a back gate electrode connected to its gate. The nineteenth transistor T19 may provide the first low gate voltage VGL_GW to the first electrode of transistor T17_1 and the gate of the eighteenth transistor T18 in response to the voltage of the first control node NQ1.

The twentieth transistor T20 may include a gate connected to the first control node NQ1, a first electrode receiving the second low gate voltage VGL2_GW, and a second electrode connected to the second inversion control node NQB2. In an embodiment, the twentieth transistor T20 may further include a back gate electrode connected to its gate. The twentieth transistor T20 may provide the second low gate voltage VGL2 to the second inversion control node NQB2 in response to the voltage of the first control node NQ1.

The fourth capacitor C4 may include a first electrode connected to the first electrode of transistor T17_1, the gate of the eighteenth transistor T18, and the second electrode of the nineteenth transistor T19, and a second electrode connected to the second inversion control node NQB2.

As such, the first selection circuit 340-1 and the second selection circuit 340-2 may control the voltage of the first inversion control node NQB1 and the voltage of the second inversion control node NQB2. For example, the first selection circuit 340-1 and the second selection circuit 340-2 may operate alternately. Therefore, the voltage of the first inversion control node NQB1 or the voltage of the second inversion control node NQB2 may have a high level.

The carry output circuit 350 may include a fourth transistor T4, a fifth transistor T5, a sixth transistor T6, a seventh transistor T7, an eighth transistor T8, a ninth transistor T9, and a first capacitor C1.

The fourth transistor T4 may include a gate receiving a third carry clock signal CLK3, a first electrode connected to the first control node NQ1, and a second electrode. The fifth transistor T5 may include a gate connected to the first inversion control node NQB1, a first electrode connected to the second electrode of the fourth transistor T4, and a second electrode connected to a carry output node NCR from which a first carry signal GW_CR1 is output. The sixth transistor T6 may include a gate connected to the second inversion control node NQB2, a first electrode connected to the second electrode of the fourth transistor T4 and the first electrode of the fifth transistor T5, and a second electrode connected to the carry output node NCR. The fourth transistor T4 may be turned on in response to the third carry clock signal CLK3 to provide the voltage of the first control node NQ1 to the first electrode of the fifth transistor T5 and the first electrode of the sixth transistor T6. The voltage of the first inversion control node NQB1 or the voltage of the second inversion control node NQB2 may have the high level. Therefore, the fifth transistor T5 or the sixth transistor T6 may be turned on in response to the voltage of the first inversion control node NQB1 or the voltage of the second inversion control node NQB2 to provide the voltage of the first control node NQ1 provided from the fourth transistor T4 to the carry output node NCR.

The seventh transistor T7 may include a gate connected to the first control node NQ1, a first electrode receiving the third carry clock signal CR_CLK3, and a second electrode connected to the carry output node NCR. In an embodiment, the seventh transistor T7 may further include a back gate electrode connected to its gate. The seventh transistor T7 may provide the third carry clock signal CR_CLK3 to the carry output node NCR in response to the voltage of the first control node NQ1.

The eighth transistor T8 may include a gate connected to the first inversion control node NQB1, a first electrode receiving the second low gate voltage VGL2_GW, and a second electrode connected to the carry output node NCR. In an embodiment, the eighth transistor T8 may further include a back gate electrode connected to its first electrode. The ninth transistor T9 may include a gate connected to the second inversion control node NQB2, a first electrode receiving the second low gate voltage VGL2_GW, and a second electrode connected to the carry output node NCR. In an embodiment, the ninth transistor T9 may further include a back gate electrode connected to its first electrode. The voltage of the first inversion control node NQB1 or the voltage of the second inversion control node NQB2 may have the high level. Therefore, the eighth transistor T8 or the ninth transistor T9 may be turned on in response to the voltage of the first inversion control node NQB1 or the voltage of the second inversion control node NQB2 to provide the second low gate voltage VGL2_GW to the carry output node NCR.

The odd gate output circuit 360_OD may include a tenth odd transistor T10_OD, an eleventh odd transistor T11_OD, a twelfth odd transistor T12_OD, an odd always-on transistor AOT_OD, and a second odd capacitor C2_OD.

The tenth odd transistor T10_OD may include a gate connected to the second control node NQ2, a first electrode receiving a third odd clock signal CLK3_OD, and a second electrode connected to an odd gate output node NGW_OD from which the first odd gate signal GW1_OD is output. In an embodiment, the tenth odd transistor T10_OD may further include a back gate electrode connected to its gate. The tenth odd transistor T10_OD may provide the third odd clock signal CLK3_OD to the odd gate output node NGW_OD in response to a voltage of the second control node NQ2.

The eleventh odd transistor T11_OD may include a gate connected to the first inversion control node NQB1, a first electrode receiving the first low gate voltage VGL_GW, and a second electrode connected to the odd gate output node NGW_OD. In an embodiment, the eleventh odd transistor T11_OD may further include a back gate electrode connected to its gate. The twelfth odd transistor T12_OD may include a gate connected to the second inversion control node NQB2, a first electrode receiving the first low gate voltage VGL_GW, and a second electrode connected to the odd gate output node NGW_OD. In an embodiment, the twelfth odd transistor T12_OD may further include a back gate electrode connected to its gate. The voltage of the first inversion control node NQB1 or the voltage of the second inversion control node NQB2 may have the high level. Therefore, the eleventh odd transistor T11_OD or the twelfth odd transistor T12_OD may be turned on in response to the voltage of the first inversion control node NQB1 or the voltage of the second inversion control node NQB2 to provide the first low gate voltage VGL_GW to the odd gate output node NGW_OD.

The odd always-on transistor AOT_OD may include a gate receiving a high gate voltage VGH_GW, a first electrode connected to the first control node NQ1, and a second electrode connected to the second control node NQ2. The transistor AOT_OD may be herein called an always-on transistor because it is turned on in response to the high gate voltage VGH_GW, which may be continually provided. The odd always-on transistor AOT_OD may separate the first control node NQ1 and the second control node NQ2. When the third odd clock signal CLK3_OD is toggled, the voltage of the second control node NQ2 may be affected. The odd always-on transistor AOT_OD may prevent the voltage of the first control node NQ1 from being affected by the voltage of the second control node NQ2. Therefore, reliability of an operation of the first stage STG1 may be improved.

The second odd capacitor C2_OD may include a first electrode connected to the second control node NQ2 and a second electrode connected to the odd gate output node NGW_OD. As described above, when the third odd clock signal CLK3_OD is toggled, the voltage of the second control node NQ2 may undesirably change. The voltage change may be reduced according to a capacitance of the second odd capacitor C2_OD. Therefore, the capacitance of the second odd capacitor C2_OD may have a value designed to reduce the change of the second control node NQ2's voltage due to the toggling.

The even gate output circuit 360_EV may include a tenth even transistor T10_EV, an eleventh even transistor T11_EV, a twelfth even transistor T12_EV, an even always-on transistor AOT_EV, and a second even capacitor C2_EV.

The tenth even transistor T10_EV may include a gate connected to the third control node NQ3, a first electrode receiving a third even clock signal CLK3_EV, and a second electrode connected to an even gate output node NGW_EV from which the first even gate signal GW1_EV is output. In an embodiment, the tenth even transistor T10_EV may further include a back gate electrode connected to its gate. The tenth even transistor T10_EV may provide the third even clock signal CLK3_EV to the even gate output node NGW_EV in response to a voltage of the third control node NQ3.

The eleventh even transistor T11_EV may include a gate connected to the first inversion control node NQB1, a first electrode receiving the first low gate voltage VGL_GW, and a second electrode connected to the even gate output node NGW_EV. In an embodiment, the eleventh even transistor T11_EV may further include a back gate electrode connected to its gate. The twelfth even transistor T12_EV may include a gate connected to the second inversion control node NQB2, a first electrode receiving the first low gate voltage VGL_GW, and a second electrode connected to the even gate output node NGW_EV. In an embodiment, the twelfth even transistor T12_EV may further include a back gate electrode connected to its gate. The voltage of the first inversion control node NQB1 or the voltage of the second inversion control node NQB2 may have the high level. Therefore, the eleventh even transistor T11_EV or the twelfth even transistor T12_EV may be turned on in response to the voltage of the first inversion control node NQB1 or the voltage of the second inversion control node NQB2 to provide the first low gate voltage VGL_GW to the even gate output node NGW_EV.

The even always-on transistor AOT_EV may include a gate receiving the high gate voltage VGH_GW, a first electrode connected to the first control node NQ1, and a second electrode connected to the third control node NQ3. The transistor AOT_EV may be herein called an always-on transistor because it is turned on in response to the high gate voltage VGH_GW, which may be continually provided. The even always-on transistor AOT_EV may separate the first control node NQ1 and the third control node NQ3. Specifically, when the third even clock signal CLK3_EV is toggled, the voltage of the third control node NQ3 may be affected. The even always-on transistor AOT_EV may prevent the voltage of the first control node NQ1 from being affected by the voltage of the third control node NQ3. Therefore, the reliability of the first stage STG1's operation may be improved.

The second even capacitor C2_EV may include a first electrode connected to the third control node NQ3 and a second electrode connected to the even gate output node NGW_EV. As described above, when the third even clock signal CLK3_EV is toggled, the voltage of the third control node NQ3 may change undesirably. The voltage change may be reduced according to a capacitance of the second even capacitor C2_EV. Therefore, the capacitance of the second even capacitor C2_EV may have a value designed to prevent or limit the voltage change at the third control node NQ3 due to the toggling.

As shown in FIG. 8, a first time point TP1 may be an approximate time point at which the first odd gate signal GW1_OD starts a transition from a non-activation level (i.e., a low level) to an activation level (i.e., the high level). At a second time point TP2, the first even gate signal GW1_EV may transition from the non-activation level to the activation level (i.e., the high level). Thus, a period during which the first odd gate signal GW1_OD has the activation level may differ from a period during which the first even gate signal GW1_EV has the activation level. The first odd gate signal GW1_OD may be applied to odd pixels of a first pixel row. The first even gate signal GW1_EV may be applied to even pixels of the first pixel row. Image data on the data line DL (see FIG. 2) intended for odd pixels may be applied to the odd pixels without being applied to the even pixels during periods in which the first odd gate signal GW1_OD is high and the first even gate signal GW1_EV is low (e.g., during the period between time points TP1 and TP2). Likewise, image data on the data line DL intended for even pixels may be applied to the even pixels without being applied to the odd pixels during periods in which the first even gate signal GW1_EV is high and the first odd gate signal GW1_OD is low (e.g., the time period directly after the signal GW1_OD goes low in FIG. 8 while the signal GW1_EV remains high). Therefore, even if the display device 10 omits a demultiplexer, a demultiplexing function may be performed.

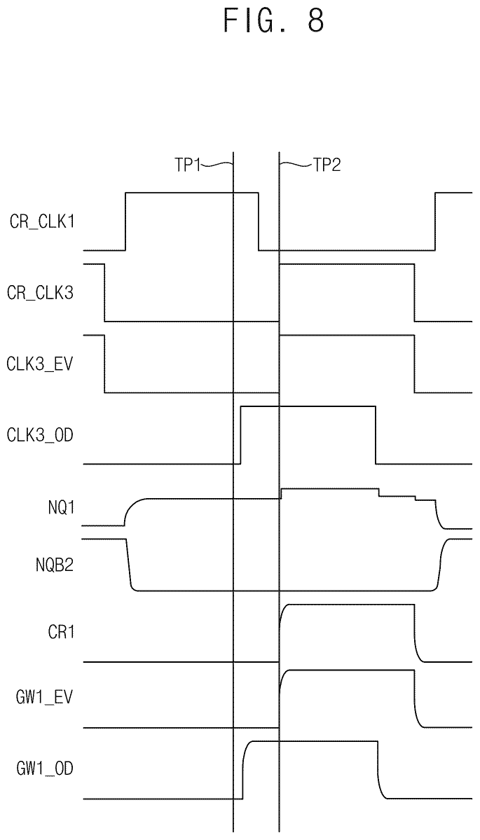

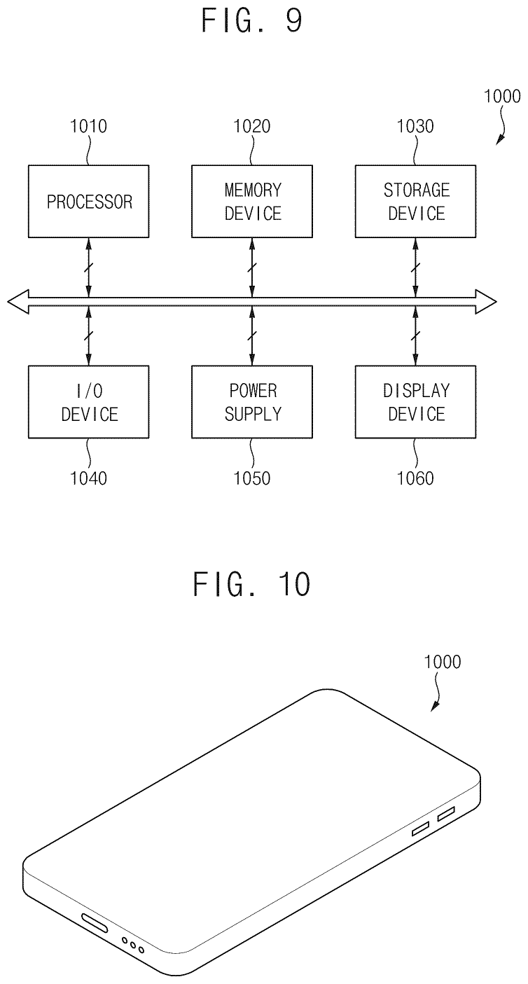

FIG. 9 is a block diagram showing an electronic device 1000. FIG. 10 is a diagram showing an embodiment in which an electronic device 1000 of FIG. 9 is implemented as a smart phone.

Referring to FIGS. 9 and 10, an electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and the like.

In an embodiment, as shown in FIG. 10, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display HMD device, and the like.

The processor 1010 may perform various computing functions. The processor 1010 may be a micro processor, a central processing unit CPU, an application processor AP, and the like. The processor 1010 may be coupled to other components via an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

The inventive concepts may be applied to any display device and any electronic device including the touch panel. For example, the inventive concepts may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

Returning to FIG. 9, the processor 1010 may perform specific calculations or tasks. According to an embodiment, the processor 1010 may be a microprocessor, a central processing unit (CPU), or the like. The processor 1010 may be connected to other components through an address bus, a control bus, a data bus, and the like. According to an embodiment, the processor 1010 may also be connected to an expansion bus such as a peripheral component interconnect (PCI) bus.

The processor 1010 may include a main processor and an auxiliary or coprocessor. The main processor may include a central processing unit (CPU). The main processor may further include one or more of a graphics processing unit (GPU), a communication processor (CP), and an image signal processor (ISP). The coprocessor may include a controller. The controller may include an interface conversion circuit and a timing control circuit. The controller may receive an image signal from the main processor, convert the data format of the image signal to match the interface specifications with the display device 1060, and output image data. The controller may output various control signals to drive the display device 1060. For example, the controller may drive the display device 1060 to display an icon on the display screen suitable for selection by a user to cause execution of an application program.

The I/O device 1040 serves as the interaction medium between a user and the electronic device 1000. The I/O device 1040 may detect an input by a part (e.g., finger) of a user's body or an input by a pen or a mouse, and generate an electric signal or data value corresponding to the input. The I/O device 1040 may include a fingerprint sensor, an input sensor, and a digitizer (all not shown). The fingerprint sensor may sense a fingerprint for biometric recognition of the user and may also measure one or more biological signals such as blood pressure, moisture, or body mass. The input sensor may sense user interactions including touch, tap, gesture, motion, spoken command, and eye movement. The input sensor includes optical sensors for image capture, eye tracking, or motion and gesture detection. Optical sensors may be infrared or semiconductor photodetectors. The input sensor includes audio and acoustic sensors, which may be MEMS microphones for voice recognition or sound-based interaction. The audio and acoustic sensors can be installed as part of the I/O device 1040 or embedded in the display panel of the display device 1060. The digitizer may generate a data value corresponding to coordinate information of input by a pen or a mouse to control movement of an onscreen cursor. The digitizer may generate the amount of change in electromagnetic energy due to the input as the data value. The digitizer may detect an input by a passive pen or transmit and receive data with an active pen or a remote.

At least one of the fingerprint sensor, the input sensor, or the digitizer may be implemented as a sensor layer formed on the top layer of a display panel of the display device 1060 through a continuous process with a process of forming elements (for example, the light emitting element, the transistor, and the like) included in the display panel.

In addition, the I/O device 1040 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

A touch screen of the I/O device 1040 may include touch sensors embedded in semiconductor layers of the display panel to sense pressure applied to the top layer (screen) of the display panel. The touch sensors can be a capacitive or a resistive type. The touch screen may serve as the primary interface for the user to select and navigate applications, control, and interact with the electronic device 1000.

The display panel of the display device 1060 may include a liquid crystal display panel, an organic light emitting display panel, or an inorganic light emitting display panel, and the type of the display panel is not particularly limited. The display panel may be of a rigid type or a flexible type that can be rolled or folded. The display device 1060 may further include a supporter, bracket, heat dissipation member, and the like that support the display panel.

The power supply 1050 may supply power to the components of the electronic device 1000. The power supply 1050 may include a battery that charges the power source voltage. The battery may include a non-rechargeable primary battery or a rechargeable secondary battery or fuel cell. The power supply 1050 may include a power management integrated circuit (PMIC). The PMIC may supply optimized power source to each of the components described above including the display device 1060.

In some embodiments, the memory device 1020 may store information such as software codes for operating an application program. The application program may include software designed to execute specific tasks or provide functionality to a user. The application program may operate under the control of the processor 1010 and may utilize data stored in the memory device 1020 to deliver a wide range of features, such as productivity tools, multimedia streaming and playback, file or mail deliveries or communication services. The application program may interact seamlessly with the I/O device 1040 (e.g., a user interface or touch screen), allowing a user to launch, navigate, and utilize the program through user inputs such as touch, tap, gesture, or voice interaction. Upon user selection of an application via a touch screen or user interface, the processor 1010 may execute the application program corresponding to the selected application retrieved from the memory device 1020 to perform functionalities of the application. For example, when a user selects a camera application by tapping the icon (or a camera application icon) presented on the display device 1060, the processor 1010 activates a camera module. The processor 1010 may transmit image data corresponding to a captured image acquired through the camera module to the display device 1060. The display device 1060 may display an image corresponding to the captured image through a display panel thereof.

As another example, when a user wishes to make a phone call, the user taps a telephone icon displayed on the display device 1060, the processor 1010 may execute a phone application program stored in the memory device 1020. A telephone keypad may be presented on the display device 1060 for the user to enter a phone number to call.

As another example, the display device 1060 may be integrated into an electronic device 1000, such as a laptop computer, smart TV, or tablet. A user wishing to access a multimedia streaming application (e.g., to watch a music video or movie) can do so by tapping the corresponding icon. This action activates the application, allowing the user to view the streamed content.

In some embodiments, the electronic device 1000 may be configured as a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 may be an AR/VR headset.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the appended claims and their equivalents.

What is claimed is:

1. A gate driver comprising:
a plurality of stages, each comprising:
a control circuit configured to control a voltage of at least one control node and a voltage of at least one inversion control node;
an odd gate output circuit configured to output an odd gate signal in response to the voltage of the at least one control node and the voltage of the at least one inversion control node; and
an even gate output circuit configured to output an even gate signal in response to the voltage of the at least one control node and the voltage of the at least one inversion control node,
wherein the odd gate signal is applied to an odd pixel, the even gate signal is applied to an even pixel, the odd pixel and the even pixel are included in a same pixel row, and the odd pixel and the even pixel share one data line.

2. The gate driver of claim 1, wherein a period in which the odd gate signal has an activation level differs from a period in which the even gate signal has the activation level.

3. The gate driver of claim 1, wherein the odd pixel and the even pixel are arranged adjacent to each other.

4. The gate driver of claim 1, wherein the at least one inversion control node includes a first inversion control node and a second inversion control node, and
the control circuit comprises:
an input circuit configured to provide an input signal to the at least one control node; and
a reset circuit configured to reset the voltage of the at least one control node.

5. The gate driver of claim 4, wherein the input circuit comprises:
a first transistor pair including a gate receiving a first carry clock signal, a first electrode receiving an input signal, and a second electrode connected to the at least one control node, and
the reset circuit comprises:
a second transistor pair including a gate receiving a reset signal, a first electrode receiving a first low gate voltage, and a second electrode connected to the at least one control node.

6. The gate driver of claim 5, wherein the control circuit further comprises:
a deterioration prevention circuit configured to prevent a deterioration of the first transistor pair of the input circuit and a deterioration of the second transistor pair of the reset circuit.

7. The gate driver of claim 6, wherein the deterioration prevention circuit includes a gate connected to the at least one control node, a first electrode receiving a high gate voltage, and a second electrode connected to a middle node of the first transistor pair and a middle node of the second transistor pair.

8. The gate driver of claim 1, wherein the at least one inversion control node includes a first inversion control node and a second inversion control node, and
the control circuit further includes:
a first selection circuit configured to control a voltage of the first inversion control node in response to a first selection signal; and
a second selection circuit configured to control a voltage of the second inversion control node in response to a second selection signal.

9. The gate driver of claim 8, wherein the first selection circuit comprises:
a thirteenth transistor pair including a gate receiving the first selection signal, a first electrode receiving the first selection signal, and a second electrode;
a fourteenth transistor including a gate connected to the second electrode of the thirteenth transistor pair, a first electrode receiving the first selection signal, and a second electrode connected to the first inversion control node;
a fifteenth transistor including a gate connected to the at least one control node, a first electrode receiving a first low gate voltage, and a second electrode connected to the second electrode of the thirteenth transistor pair and the gate of the fourteenth transistor;
a sixteenth transistor including a gate connected to the at least one control node, a first electrode receiving a second low gate voltage, and a second electrode connected to the first inversion control node; and
a third capacitor including a first electrode connected to the second electrode of the thirteenth transistor pair, the gate of the fourteenth transistor, and a first electrode of the fifteenth transistor, and a second electrode connected to the first inversion control node, and
the second selection circuit comprises:
a seventeenth transistor pair including a gate receiving the second selection signal, a first electrode receiving the second selection signal, and a second electrode;
an eighteenth transistor including a gate connected to the second electrode of the seventeenth transistor pair, a first electrode receiving the second selection signal, and a second electrode connected to the second inversion control node;
a nineteenth transistor including a gate connected to the at least one control node, a first electrode receiving the first low gate voltage, and a second electrode connected to the second electrode of the seventeenth transistor pair and the gate of the eighteenth transistor;
a twentieth transistor including a gate connected to the at least one control node, a first electrode receiving the second low gate voltage, and a second electrode connected to the second inversion control node; and
a fourth capacitor including a first electrode connected to the second electrode of the seventeenth transistor pair, the gate of the eighteenth transistor and a second electrode connected to the second inversion control node.

10. The gate driver of claim 1, further comprising:
a carry output circuit configured to output a carry signal in response to the voltage of the at least one control node and the voltage of the at least one inversion control node.

11. The gate driver of claim 10, wherein the at least one inversion control node includes a first inversion control node and a second inversion control node, and
the carry output circuit comprises:
a fourth transistor including a gate receiving a second carry clock signal, a first electrode connected to the at least one control node, and a second electrode;
a fifth transistor including a gate connected to the first inversion control node, a first electrode connected to the second electrode of the fourth transistor, and a second electrode connected to a carry output node from which a carry signal is output;
a sixth transistor including a gate connected to the second inversion control node, a first electrode connected to the second electrode of the fourth transistor and the first electrode of the fifth transistor, and a second electrode connected to the carry output node;
a seventh transistor including a gate connected to the at least one control node, a first electrode receiving the second carry clock signal, and a second electrode connected to the carry output node;
an eighth transistor including a gate connected to the first inversion control node, and a first electrode receiving a second low gate voltage, and a second electrode connected to the carry output node; and
a ninth transistor including a gate connected to the second inversion control node, a first electrode receiving the second low gate voltage, and a second electrode connected to the carry output node.

12. The gate driver of claim 1, wherein the at least one inversion control node includes a first inversion control node and a second inversion control node, and
the odd gate output circuit comprises:
a tenth odd transistor including a gate connected to the at least one control node, a first electrode receiving an odd clock signal, and a second electrode connected to an odd gate output node from which the odd gate signal is output;
a eleventh odd transistor including a gate connected to the first inversion control node, a first electrode receiving a first low gate voltage, and a second electrode connected to the odd gate output node; and
a twelfth odd transistor including a gate connected to the second inversion control node, a first electrode receiving the first low gate voltage, and a second electrode connected to the odd gate output node.

13. The gate driver of claim 12, wherein the at least one control node includes a first control node and a second control node, and
the odd gate output circuit further comprises:
an odd always-on transistor including a gate receiving a high gate signal, a first electrode connected to the first control node, and a second electrode connected to the second control node.

14. The gate driver of claim 1, wherein the at least one inversion control node includes a first inversion control node and a second inversion control node, and
the even gate output circuit comprises:
a tenth even transistor including a gate connected to the at least one control node, a first electrode receiving an even clock signal, and a second electrode connected to an even gate output node from which the even gate signal is output;
a eleventh even transistor including a gate connected to the first inversion control node, a first electrode receiving a low gate voltage, and a second electrode connected to the even gate output node; and
a twelfth even transistor including a gate connected to the second inversion control node, a first electrode receiving a first low gate voltage, and a second electrode connected to the even gate output node.

15. The gate driver of claim 14, wherein the at least one control node includes a first control node and a third control node, and
the even gate output circuit further comprises an odd always-on transistor including a gate receiving a high gate signal, a first electrode connected to the first control node, and a second electrode connected to the third control node.

16. A display device, comprising:
a display panel including an odd pixel and an even pixel included in a same pixel row and sharing one data line;
a data driver configured to provide an odd data voltage and an even data voltage to the one data line;
a gate driver configured to provide an odd gate signal and an even gate signal to the odd pixel and the even pixel, respectively; and
a driving controller configured to control the data driver and the gate driver,
wherein the odd pixel receives the odd data voltage in response to the odd gate signal, and the even pixel receives the even data voltage in response to the even gate signal,
wherein the gate driver comprises a plurality of stages, and each of the plurality of stages comprises:
a control circuit configured to control a voltage of at least one control node and a voltage of at least one inversion control node;
an odd gate output circuit configured to output an odd gate signal in response to the voltage of the at least one control node and the voltage of the at least one inversion control node; and
an even gate output circuit configured to output an even gate signal in response to the voltage of the at least one control node and the voltage of the at least one inversion control node.

17. The display device of claim 16, wherein a period in which the odd gate signal has an activation level differs from a period in which the even gate signal has the activation level.

18. The display device of claim 16, wherein the at least one inversion control node includes a first inversion control node and a second inversion control node, and
the control circuit comprises:
an input circuit configured to provide an input signal to the at least one control node; and
a reset circuit configured to reset the voltage of the at least one control node.

19. The display device of claim 18, wherein
the input circuit comprises:
a first transistor including a gate receiving a first carry clock signal, a first electrode receiving an input signal, and a second electrode connected to the at least one control node, and
the reset circuit comprises:
a second transistor including a gate receiving a reset signal, a first electrode receiving a first low gate voltage, and a second electrode connected to the at least one control node.

20. An electronic device, comprising:
a display panel including an odd pixel and an even pixel included in a same pixel row and sharing one data line;
a data driver configured to provide an odd data voltage and an even data voltage to the one data line;
a gate driver configured to provide an odd gate signal and an even gate signal to the odd pixel and the even pixel, respectively;
a driving controller configured to control the data driver and the gate driver; and
a processor configured to control the driving controller,
wherein the odd pixel receives the odd data voltage in response to the odd gate signal, and the even pixel receives the even data voltage in response to the even gate signal,
wherein the gate driver comprises a plurality of stages, and
wherein each of the stages comprises:
a control circuit configured to control a voltage of at least one control node and a voltage of at least one inversion control node;
an odd gate output circuit configured to output an odd gate signal in response to the voltage of the at least one control node and the voltage of the at least one inversion control node; and
an even gate output circuit configured to output an even gate signal in response to the voltage of the at least one control node and the voltage of the at least one inversion control node.
